(19) United States
(12) Patent Application Publication
(10) Pub. No.: US 2010/0069074 A1
(43) Pub. Date: Mar. 18, 2010

(54) WIRELESS-RESOURCE BROKER

(75) Inventors: Muralidharan S. Kodialam, Marlboro, NJ (US); Tirunell V. Lakshman, Morganville, NJ (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: Lucent Technologies Inc., Murray Hill, NJ (US)

(21) Appl. No.: 12/209,655

(22) Filed: Sep. 12, 2008

(51) Int. Cl. H04W 72/00

(52) U.S. Cl. 455/450

(57) ABSTRACT

In one embodiment, a wireless-resource broker employs a self-enforcing spectrum-sharing policy, e.g., the expected utility (e.g., rate) a user obtains by following the policy provided by the broker is not less than the expected utility that the user obtains by switching to some other strategy. Each user is associated with one or more transmitter-receiver pairs, e.g., a transmitter of a wireless device and a receiver of a base station in communication via a wireless channel. The broker receives, as input, user parameters characterizing one or more of the transmitters and/or receivers and resource parameters characterizing one or more available spectrum blocks. The broker solves a linear-programming problem to generate and transmit a recommended policy for one or more users. The policy for each user includes information such as the spectrum block(s) to which the user is assigned, the transmission power for the user, and the transmission rate for the user.

### BACKGROUND OF THE INVENTION

1. Field of the Invention

The present invention relates to wireless communications, and, in particular, to spectrum sharing in wireless networks.

2. Description of the Related Art

In a traditional cellular network, a wireless device typically communicates with a plurality of cells that are served by base stations. A typical cellular system may include hundreds of cells and may serve thousands of wireless devices. The cells generally serve as nodes in the system from which links are established between wireless devices and a Mobile Telephone Switching Office (MTSO) by way of the base stations serving the cells. Through the cellular network, a duplexed radio-communication link may be effected between two wireless devices or, through a Public Switched-Telephone Network (PSTN), between a wireless device and a landline device.

Several types of access techniques are conventionally used to provide wireless services to users of cellular systems. Traditional analog cellular systems generally create communications channels using a system referred to as Frequency-Division Multiple Access (FDMA), wherein discrete spectrum (or frequency) bands serve as channels over which wireless devices communicate with base stations. Typically, these bands are reused in geographically-separated cells in order to increase system capacity.

Modern digital cellular systems typically utilize different multiple-access techniques, such as Time-Division Multiple Access (TDMA) and/or Code-Division Multiple Access (CDMA), to provide increased spectral efficiency. In TDMA systems, such as those conforming to the GSM or IS-136 standards, carriers are divided into sequential time slots that are assigned to multiple channels, such that a plurality of channels may be multiplexed on a single carrier. CDMA systems, such as those conforming to the IS-95 Standard, achieve increased channel capacity by using “spread-spectrum” techniques, wherein a channel is defined by modulating a data-modulated carrier signal by a unique spreading code that spreads an original data-modulated carrier over a wide portion of the frequency spectrum in which the communications system operates.

For both voice and data communication in a traditional cellular network, users are scheduled from base stations using TDMA or CDMA schemes. The Federal Communication Commission (FCC) Spectrum Policy Taskforce has observed that a large fraction of the wireless spectrum is under-utilized for significant periods of time, and that utilizing these frequencies both temporally and spatially can lead to significant increase in wireless capacity.

In dynamic-spectrum systems, the available spectrum is shared dynamically by multiple autonomous users. Advances in Software-Defined Radio (SDR) technologies make it possible for a user to use different parts of the wireless spectrum in a dynamic manner. However, if each user arbitrarily accesses some part of the spectrum for its own use, then a significant amount of interference between the users results.

### SUMMARY OF THE INVENTION

In one embodiment, the present invention provides a method for allocating wireless resources among a plurality of users. The method includes the steps of: (a) receiving one or more user parameters characterizing at least one of one or more receivers and one or more transmitters associated with one or more of the users; (b) receiving one or more resource parameters characterizing one or more wireless resources; (c) generating, based on the one or more user parameters and the one or more resource parameters, a policy for using one or more of the wireless resources by a particular user, wherein the policy is such that an expected utility that the particular user obtains by adopting the policy is not less than the expected utility that the particular user obtains by adopting an alternative strategy; and (d) transmitting the policy for the particular user.

In another embodiment, the present invention provides a wireless-resource broker for allocating wireless resources among a plurality of users. The wireless-resource broker includes a receiver, a processor, and a transmitter. The receiver is adapted to: (a) receive one or more user parameters characterizing at least one of one or more receivers and one or more transmitters associated with one or more of the users; and (b) receive one or more resource parameters characterizing one or more wireless resources. The processor is adapted to generate, based on the one or more user parameters and the one or more resource parameters, a policy for using one or more of the wireless resources by a particular user, wherein the policy is such that an expected utility that the particular user obtains by adopting the policy is not less than the expected utility that the particular user obtains by adopting an alternative strategy. The transmitter is adapted to transmit the policy for the particular user.

In a further embodiment, the present invention provides a communications device for use with a wireless-resource broker for allocating wireless resources among a plurality of users. The communications device includes a receiver and a processor. The receiver is adapted to receive, from the wireless-resource broker, a policy for using one or more of the wireless resources. The processor is adapted to selectively adopt or ignore the policy.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a block diagram of a system that includes an exemplary wireless-resource broker in one embodiment of the invention; and

FIG. 2 is a flow diagram illustrating an exemplary method of using a wireless-resource broker consistent with one embodiment of the present invention.

### DETAILED DESCRIPTION

In principle, there are two diametrically opposite approaches to sharing wireless resources among multiple users.

At one extreme, the first approach involves the use of a specific multiple-access scheduling protocol. In this approach, all users are expected to use that specific multiple-access protocol, and the scheduler can penalize any user that violates the protocol. This is the approach that is followed in traditional cellular networks. The multiple-access protocol is typically time-division multiple access (TDMA), in which each user is given a slice of time, or code-division multiple access (CDMA), in which a plurality of different codes are partitioned between the users. Since, in CDMA and TDMA, all of the wireless devices are controlled from the base station, it is relatively easy to enforce compliance.

At the other extreme, the second approach is a “free-for-all” approach, in which there is no centralized scheduler, and users use the wireless channel(s) as they please. This typically leads to very inefficient use of wireless resources and is generally not used in practice. These schemes have been studied in the literature using game-theory techniques, and the Nash equilibrium rate (a strategy vector that maximizes the payoff of a given player, with the strategies of all other players remaining fixed) obtained by users has been characterized in several scenarios.

Embodiments of the present invention deviate from these two extremes in favor of an intermediate scheme that employs a wireless-resource broker to coordinate the users in the system. Unlike the cellular scheduler of the first approach, a wireless-resource broker might not have the ability to enforce its policy decisions. As a result, an autonomous user will have an incentive to violate the policy provided by the wireless-resource broker if it is not in the self-interest of the user to follow this policy.

A wireless-resource broker consistent with embodiments of the invention employs a spectrum-sharing policy in such a way that it is self-enforcing. In other words, the policy is designed such that no user has an incentive to violate this policy, and it is in the best interest of the user to comply with the policy. Moreover, from among a plurality of different possible policies that are self-enforcing, the broker chooses a policy that optimizes some system-wide objective, such as throughput or fairness.

In a self-enforcing approach to sharing wireless resources, consistent with embodiments of the present invention, a wireless-resource broker, in like manner to a conventional cellular scheduler, has a centralized view of the system. However, unlike a scheduler, the broker might not employ any enforcement mechanism. This is due to the fact that it is extremely difficult or impossible to enforce penalties for violation when the users are autonomous and are not subscribers of a single provider or wireless carrier.

In one embodiment, a wireless device in communication with a base station is associated with two transmitter-receiver pairs: (1) an uplink pair consisting of a transmitter in the wireless device and a receiver at the base station and (2) a downlink pair consisting of a transmitter at the base station and a receiver in the wireless device.

It should be understood that a single wireless device or base station may include one or more transmitters and one or more receivers of the same or of varying types (e.g., CDMA, TDMA, GSM, 802.11 WiFi, etc.), and that a wireless-resource broker consistent with embodiments of the present invention may be capable of providing one or more policies applicable to more than a single transmitter or receiver within a wireless device or base station.

Each transmitter and receiver may include, e.g., one or more conventional or Software-Defined Radios (SDRs), i.e., radios whose channel modulation waveforms are defined in software. These waveforms may be generated at a transmitter as sampled digital signals, converted from digital to analog via a wideband digital-to-analog (DAC) converter, and then possibly upconverted from intermediate frequency (IF) to radio frequency (RF). The receiver, similarly, employs a wideband analog-to-digital converter (ADC) that captures all of the channels of the software radio node. The receiver then extracts, downconverts, and demodulates the channel waveform using software running on a processor.

Each transmitter and receiver may implement, e.g., one or more conventional antennas or adaptive or “smart” antennas or antenna arrays whose signal-processing algorithms are adapted to continuously distinguish between desired signals, multi-path, and interfering signals and to calculate the arrival directions of the desired signals. Although conventional antennas typically have a given physical length tuned for a given spectrum band or block, “smart” antennas and antenna arrays can instead be used with different spectrum bands or blocks, e.g., by dynamically changing the antenna length and/or using an active antenna containing one or more arrays of antenna elements.

The available spectrum is partitioned into spectrum bands. For example, in the United States, such spectrum bands might include the 850 MHz band used for 2G (second generation) cellular telephony; the 1.9 GHz band used for Personal Communications Service (PCS); the 5 GHz and 2.4 GHz public spectrum bands used for 802.11 WiFi communications; and the 1.7 and 2.1 GHz spectrum bands used for Advanced Wireless Services (AWS), including Universal Mobile Telecommunications System (UMTS) and High-Speed Downlink Packet Access (HSDPA). Some of these spectrum bands may further be divided into sub-bands or blocks. For example, AWS divides the 1.7 and 2.1 GHz spectrum bands into six blocks, with each block having either a 10 MHz or a 20 MHz bandwidth (AWS Block A: 1710-1720 MHz downlink and 2110-2120 MHz uplink; AWS Block B: 1720-1730 MHz downlink and 2120-2130 MHz uplink; AWS Block C: 1730-1735 MHz downlink and 2130-2135 MHz uplink; AWS Block D: 1735-1740 MHz downlink and 2135-2140 MHz uplink; AWS Block E: 1740-1745 MHz downlink and 2140-2145 MHz uplink; and AWS Block F: 1745-1755 MHz downlink and 2145-2155 MHz uplink). A wireless-resource broker consistent with embodiments of the invention may divide bandwidth into entire spectrum bands (e.g., 1.9 GHz spectrum band, 1.7 GHz spectrum band, etc.), blocks within those bands (e.g., AWS Block A, AWS Block B, etc.), or a combination of both, and the term “spectrum block,” as used herein, should be understood to encompass any or all of these possibilities.

The wireless-resource broker receives, as input, user parameters characterizing one or more of the transmitters and/or receivers, e.g., the maximum transmission power of a transmitter. In addition, user parameters may also reflect restrictions imposed by the individual users themselves on the spectrum blocks (or other wireless resources) that those users can use, due, e.g., to the fact that a given user's wireless device might not be able to tune into all spectrum blocks or may be limited to certain wireless resources due to transmitter/receiver power limitations. User parameters can also include other information, such as location-based information generated by a global positioning system (GPS) or radiofrequency identification (RFID) transmitter (e.g., contained within the user's wireless device), indicating the geographic proximity of the user to the wireless resources being allocated. For example, a wireless device might transmit to the wireless-resource broker a list of all wireless resources that appear to be available to it.

The wireless-resource broker also receives resource parameters characterizing one or more of the available spectrum blocks, e.g., the thermal noise and external interference in each of the spectrum blocks.

In one embodiment, a time-slotted system is used. In each time slot, the wireless-resource broker provides a policy to one or more users. The policy for each user, in general, includes information such as (i) the spectrum block(s) to which the user is assigned, (ii) the transmission power for the user, and (iii) the transmission rate for the user. These parameters are selected by the wireless-resource broker such that the policy is self-enforcing.

In order to maintain this self-enforcing property, the policy should be such that the expected utility (e.g., rate or other parameter) that a user obtains by following the policy provided by the wireless-resource broker is not less than the expected utility that the same user obtains by switching to some other policy. This reduces or eliminates the incentive for the user to deviate from the policy specified by the wireless-resource broker.

This self-enforcing property can be expressed in the form of a linear constraint over the policy space (the domain of all spectrum blocks over which the wireless-resource broker is configured to provide policies to users). The objective for the wireless-resource broker can be some system-wide performance parameter, such as maximizing the expected throughput. Therefore, the wireless-resource broker's problem can be formulated as a linear-programming problem. When this linear-programming problem is solved, the output is the set of policies that are to be used, along with the fraction of time that each policy is used. In each time slot, the wireless-resource broker chooses a policy in proportion to the amount of time that the policy is used and informs one or more users (i) which spectrum block(s) to use and (ii) which power-rate combination to use for transmission in the spectrum block(s). Using the solution of the linear-programming problem makes the policy self-enforcing, and therefore, each user is likely to follow the policy suggested by the wireless-resource broker.

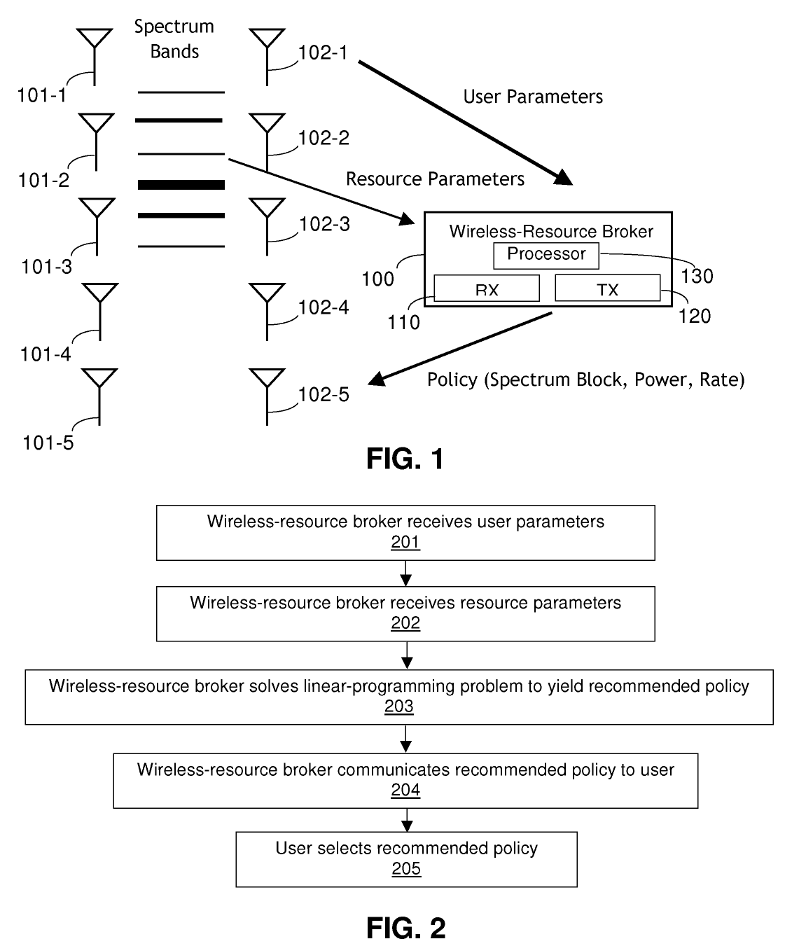

FIG. 1 is a block diagram of a system that includes an exemplary wireless-resource broker 100 for allocating spectrum blocks, in one embodiment of the invention. As shown, there are five users, each user associated with two transmitter-receiver pairs, i.e., a transmitter 101-n and a receiver (not shown) residing in a wireless device being used by the user and a corresponding receiver 102-n and a transmitter (not shown) residing at a base station. It should be understood that, while a wireless device typically includes a transmitter and a receiver in communication with a corresponding receiver and transmitter of a base station, only one of those transmitter/receiver pairs (i.e., a transmitter of the wireless device and a receiver of a corresponding base station) for each user will be discussed in this embodiment. However, a wireless-resource broker consistent with embodiments of the invention could provide policies for either one or both of these transmitter-receiver pairs.

One or more of the transmitters 101-n and receivers 102-n are in communication with wireless-resource broker 100, which includes a receiver 110, a transmitter 120, and a processor 130, via one or more wireless communications channels (e.g., a dedicated band or a shared band). In this example, there are six spectrum blocks, and, in FIG. 1, lines of different thicknesses are used to represent the fact that all spectrum blocks might not have equal bandwidth. It should be noted that there is no direct relationship between the number of users and the number of spectrum blocks. If there are fewer spectrum blocks than users, then multiple users can be assigned to one or more spectrum blocks, and the user rates are adjusted to take this fact into consideration.

The wireless-resource broker obtains user parameters and resource parameters either on a periodic basis or upon the occurrence of certain events, such as when a new user enters the system or an existing user leaves the system. The user parameters may be obtained, e.g., from one or more transmitters corresponding to one or more users (such as transmitters 101-n). The resource parameters may be obtained, e.g., from resources (not shown) of one or more wireless networks, wherein the resources are adapted to provide information about the available spectrum blocks of those networks. It should be understood that, although possible, it is not necessary for the wireless-resource broker actually to be connected to the network resources being allocated, and information regarding these resources can be obtained from other sources such as network providers or wireless carriers, e.g., either in advance, on a periodic basis, or on an ad hoc basis.

The wireless-resource broker includes processor 130, which uses the user and resource parameters to formulate a linear-programming problem whose solution yields a self-enforcing policy. Once this linear-programming problem is solved, the policy is transmitted to one or more users. Since there is nothing to be gained by violating the policy, users will follow the policy they receive, and therefore, the policy is self-enforcing.

An exemplary linear-programming problem for a wireless-resource broker consistent with the present invention has primal and dual problems and solutions that may be characterized as follows:

1. If the primal problem has a variables and b resource constraints, then the dual problem will have b variables and a resource constraints, where the constraint matrix of the dual problem is the transpose of the constraint matrix of the primal problem.

2. There is a one-to-one correspondence between the primal constraints and the dual variables, i.e., a variable in the dual problem is paired with an inequality (i.e., constraint) in the primal problem, and similarly for the primal variables and the dual constraints.

3. The objective function of the dual problem is determined by the right-hand side of the primal constraints, and similarly for the objective function of the primal problem and the right-hand side of the dual constraints.

Such a linear-programming problem may be formulated as follows. In a system having n users and m spectrum blocks, time is divided into a plurality of slots. In each slot, each user can adopt a possible transmission strategy, where Sⱼ denotes the set of strategies for user j, and S=(S₁, S₂, . . . , Sₙ) denotes the strategy space for the problem. Each strategy reflects, e.g., one or more possible spectrum blocks for the user, and may further reflect other information, e.g., a transmission power and/or transmission rate for the user. The term “policy” is used herein to denote a strategy that is provided by a wireless-resource broker and recommended for adoption by the user.

The probability that the wireless-resource broker chooses a given strategy sε S is denoted by p(s). In one embodiment, the transmission strategy for user j in each time slot includes the following three components: (i) the spectrum block(s) in which the transmission is to take place, (ii) a transmission power, and (iii) a transmission rate. It is assumed that the power and rate are discretized, and that there are therefore a finite number of strategies. The utility that user j experiences in a given time slot will depend on the strategy adopted by other users. The utility that user j experiences when strategy sε S is used is denoted by uⱼ(s). One example of utility is the achieved data rate, although other measures of utility are possible, e.g., error rate. Two alternative strategies for user j are denoted as s̅ⱼ, \tilde{s}ⱼ ε Sⱼ. Assuming that the broker's policy for user j is strategy s̅ⱼ, the linear program employs the following constraints in order to reduce or eliminate the incentive for the user to switch from strategy S̅ⱼ:

$${\sum }_{s ∈ S : {s}_{j} = {\overline{s}}_{j}} p ( s ) {u}_{j} ( s ) \geq {\sum }_{s ∈ S : {s}_{j} = {\overline{s}}_{j}} p ( s ) {u}_{j} ( {s}_{1} , {s}_{2} , … , {\tilde{s}}_{j} , … , {s}_{n} ) ∀ {\overline{s}}_{j} , {\tilde{s}}_{j} ∈ {S}_{j} ∀ j .$$

The right-hand term represents the expected utility if user j switches to strategy \tilde{s}ⱼ instead of using strategy s̅ⱼ, the policy suggested by the broker. In addition, since p(s) represents probability, the sum

$${\sum }_{s ∈ S} p ( s ) = 1.$$

The only unknowns in the linear-programming problem are the probabilities p(s), and therefore, the problem has linear constraints. The wireless-resource broker can thus optimize any linear objective function over these constraints in order to obtain desired operating conditions. For example, a weighted sum of the expected utilities can be used, where the weights are chosen by the broker. If wⱼ is the weight for user j, then the objective function is:

$${\sum }_{j} {w}_{j} {\sum }_{s ∈ S} p ( s ) {u}_{j} ( s ) .$$

Once a solution to the linear-programming problem has been obtained, the resulting policy (e.g., spectrum block(s), transmission power, and transmission rate) is then communicated from the wireless-resource broker to the user. This communication could be in the form of, e.g., a standard or special broadcast message, Short Message Service (SMS) message, or other type of message. Depending on the particular software and hardware being used by the user, a wireless device could be configured to receive such message and adopt the spectrum block and/or other parameters automatically based on the policy specified in the message. In alternative embodiments, the user may have to view the message and manually adopt a strategy. This latter procedure might be comparable to the manner in which a user with a laptop currently selects a public 802.11 WiFi network from among a number of possible access points, except that, in the case of embodiments of the present invention, the user would have received a message containing the policy recommended by the wireless-resource broker and would be informed of the WiFi network recommended by the wireless-resource broker, prior to the user making a selection.

FIG. 2 is a flow diagram illustrating an exemplary method of using a wireless-resource broker consistent with one embodiment of the present invention. As shown, at step 201, the wireless-resource broker receives user parameters from transmitters and receivers corresponding to one or more users. At step 202, the wireless-resource broker receives resource parameters from one or more network providers or wireless carriers. Next, at step 203, the wireless-resource broker solves a linear-programming problem to yield a recommended policy (e.g., spectrum block(s), transmission power, and transmission rate) for a user. At step 204, the wireless-resource broker communicates the recommended policy to the user. At step 205, the user adopts the recommended policy as a strategy.

Embodiments of the present invention are of particular benefit in networks where user compliance to network policy is hard to verify and enforce. Examples of such networks are instant-infrastructure or dynamic-spectrum access networks where the network deployment is not pre-planned and instead is configured dynamically. In dynamic-spectrum access networks, a wireless-resource broker can coordinate spectrum sharing but has limited capability to monitor user behavior and enforce compliance. Embodiments of the invention address this situation, where coordination of access is needed but lack of infrastructure capability implies that coordination is done in a self-enforcing manner, such that users do not fare better by deviating from the behavior suggested by the wireless-resource broker.

Whereas existing solutions are aimed at traditional cellular networks having a central coordinator so that the network is capable of monitoring and enforcing user compliance, embodiments of the present invention can be used with new networks deployed on demand, such as instant-infrastructure networks, where lack of planned deployment makes monitoring and enforcement of user compliance difficult. Hence, to prevent poor performance due to users optimizing their own performance (in the absence of compliance enforcement), embodiments of the present invention use self-enforcing coordination where users have incentive to comply with network needs, since they will not be able to obtain better performance by non-compliance with network requests. Accordingly, networks having limited capability to keep track of user behavior and monitor compliance, such as new dynamic-spectrum access networks being proposed and other networks lacking careful deployment planning, would benefit tremendously from the implementation of a self-enforcing mechanism consistent with the present invention.

A wireless-resource broker consistent with the present invention could be used not only to allocate spectrum blocks, but could be used to allocate other wireless network resources as well. For example, a wireless-resource broker could allocate wireless network access points (or “hotspots”), even if those access points all are within the same spectrum block. Accordingly, the term “wireless resources” should be understood to include spectrum bands, spectrum blocks within spectrum bands, wireless network access points, and other types of network resources to be allocated among a plurality of wireless users.

The present invention may have particular utility in the context of Voice-over-Internet-Protocol (VoIP) telephony. VoIP calls through the Internet or an intranet, which are usually relatively inexpensive or free, are typically made using a VoIP-enabled telephone or a personal computer running specialized software. However, these calls traditionally have required that a user manually and consciously initiate VoIP communications. VoIP functionality may be provided in a wireless device used in conjunction with certain embodiments of the present invention, such that the wireless device can permit relatively low-cost or no-cost local wireless facilities, such as VoIP, VoWLAN, or WiFi, to be recommended by a wireless-resource broker where appropriate, rather than a higher-cost traditional satellite or terrestrial cellular-based network. Switching to VoIP can be performed either automatically, or by prompting a user to alert the user of the availability of a potentially less-expensive VoIP service wherever available. A cellular wireless device used in conjunction with certain embodiments of the present invention is therefore desirably VoIP- and/or VoWLAN-enabled, adapted to log on automatically to subscribed available services, and may be configured to scan continually for available networks, just as would be done by a conventional WiFi-enabled device, such as an Ethernet card for a laptop or a PDA. The introduction of such versatile wireless devices would also advantageously allow certain load-balancing profiles to be assumed, so as to curtail the need for further build-out of existing cellular networking-support infrastructures.

In practical terms, a user of a wireless device in conjunction with a wireless-resource broker consistent with certain embodiments of the invention, who is using the device for a voice call over a 3G (third-generation) network such as UTMS or CDMA2000, could walk into a WiFi “hotspot” and then, based on a wireless-resource broker's recommendation, be switched automatically or manually to the WiFi network for the remainder of the call, thereby enjoying cost savings and/or improved call quality. Thus, an algorithm implemented in such a wireless device might be adapted to periodically receive messages from a wireless-resource broker, decide whether or not to switch to an alternative recommended service, and effect hand-off to the alternative service.

It should be understood that appropriate transceiver circuitry is provided within each wireless device and base station to effect the actual communications processing with the various services, in the various embodiments of the present invention. Such transceiver circuitry is adapted to support the various radio-access technologies, modulation schemes, and spectrum bands or blocks appropriate for the services supported by the corresponding wireless devices and base stations. It should further be recognized that a particular embodiment of the present invention may support one or more of the modes of operation described herein, but not necessarily all of these modes of operation.

In certain embodiments, a wireless-resource broker consistent with the present invention may be adapted to recommend more than one available spectrum block concurrently. There are several reasons why this might be desirable. First, in a scenario where different pairs of uplink and downlink spectrum blocks are used together (e.g., AWS uses 1.7 GHz for uplink and 2.1 GHz for downlink), the wireless-resource broker could recommend different uplink and downlink spectrum blocks to be used concurrently. Second, recommending more than one available spectrum block may also be useful in other scenarios, such as where the linear program determines that two or more spectrum blocks are optimal for a given user, and it would then be up to the user to decide which of those optimal spectrum blocks might be more preferable to the user and select that block. Third, recommending more than one available spectrum block could also permit, e.g., concurrent use of data and/or voice communications on a wireless device. For example, a wireless device could use a WiFi service for VoIP communications while using a GSM service to provide driving directions in real time, and different spectrum blocks could be used for data and voice.

Examples of wireless resources, spectrum bands, spectrum blocks, and services used in embodiments of the present invention may include, but are not limited to, the following technologies: Advanced Wireless Services (AWS); Evolution, Data-Only (1xEV-DO); Evolution, Data-Voice (1xEV-DV); Radio Transmission Technology (1xRTT); Advanced Mobile Phone Service (AMPS); Code-Division Multiple Access (CDMA); CDMA2000; Enhanced Data rates for GSM Evolution (EDGE); General Packet Radio Service (GPRS); Global System for Mobile Communications (GSM); High-Speed Downlink Packet Access (HSDPA); integrated Digital Enhanced Network (iDEN); Push-to-talk (PTT); Time-Division Multiple Access (TDMA); Universal Mobile Telephone Service (UMTS); Worldwide Interoperability for Microwave Access (WiMax); 802.11-standard communications; Wireless Fidelity (WiFi); Voice over Internet Protocol (VoIP); Voice over Wireless Local-Area Network (VoWLAN); Bluetooth; WiBree; and ZigBee; as well as other voice- and/or data-communications services, such as those provided by Wide-Area Networks (WANs), Personal-(or Processor-) Area Networks (PANs), indoor wireless LANs, very-high-speed fixed and mobile wireless (point-to-multipoint) networks, acoustic communications, and broadcast systems, such as High-Definition Television (HDTV). In certain embodiments of the invention, wireless resources being allocated by a broker could include, e.g., CDMA codes or TDMA time slots.

The term “strategy” should be construed to include the adoption of one or more wireless resources, e.g., spectrum bands, spectrum blocks, network access points, services, and other wireless resources, as might be recommended by a wireless-resource broker consistent with embodiments of the present invention. A single strategy may apply to more than one transmitter and/or receiver. The term “policy” should be construed to mean a strategy provided by a wireless-resource broker consistent with embodiments of the invention.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. A method for allocating wireless resources among a plurality of users, the method comprising the steps of:
(a) receiving one or more user parameters characterizing at least one of one or more receivers and one or more transmitters associated with one or more of the users;
(b) receiving one or more resource parameters characterizing one or more wireless resources;
(c) generating, based on the one or more user parameters and the one or more resource parameters, a policy for using one or more of the wireless resources by a particular user, wherein the policy is such that an expected utility that the particular user obtains by adopting the policy is not less than the expected utility that the particular user obtains by adopting an alternative strategy; and
(d) transmitting the policy for the particular user.

2. The invention of claim 1, wherein:
the one or more user parameters include at least one of: (i) maximum transmission power of a transmitter, (ii) identification of one or more spectrum blocks usable by a transmitter or receiver, (iii) spectrum codes, and (iv) spectrum time slots;
the one or more resource parameters include at least one of: (i) thermal noise corresponding to a spectrum block and (ii) external interference corresponding to a spectrum block; and
the policy includes at least one of: (i) one or more spectrum blocks for the particular user to use, (ii) a transmission power for the particular user to use, (iii) a transmission rate for the particular user to use, (iv) a network access point for the particular user to use, (v) a spectrum code for the particular user to use, and (vi) a spectrum time slot for the particular user to use.

3. The invention of claim 1, wherein the policy is generated by solving a linear-programming problem having primal and dual sets of constraints based on the one or more user parameters and the one or more resource parameters.

4. The invention of claim 1, wherein, after step (d), at least one of a transmitter and a receiver associated with the particular user automatically adopts the transmitted policy.

5. The invention of claim 1, wherein, after step (d), at least one of a transmitter and a receiver associated with the particular user is manually configured by a human actor to adopt the policy.

6. The invention of claim 1, wherein at least one of the one or more receivers and the one or more transmitters comprises at least one of: (i) a software-defined radio and (ii) an antenna or antenna array adapted to be tuned dynamically to different spectrum bands or blocks.

7. The invention of claim 1, wherein no enforcement takes place to ensure that the particular user adopts the transmitted policy.

8. A wireless-resource broker for allocating wireless resources among a plurality of users, the wireless-resource broker comprising:
a receiver adapted to:
(a) receive one or more user parameters characterizing at least one of one or more receivers and one or more transmitters associated with one or more of the users; and
(b) receive one or more resource parameters characterizing one or more wireless resources;
a processor adapted to generate, based on the one or more user parameters and the one or more resource parameters, a policy for using one or more of the wireless resources by a particular user, wherein the policy is such that an expected utility that the particular user obtains by adopting the policy is not less than the expected utility that the particular user obtains by adopting an alternative strategy; and
a transmitter adapted to transmit the policy for the particular user.

9. The invention of claim 8, wherein:
the one or more user parameters include at least one of: (i) maximum transmission power of a transmitter, (ii) identification of one or more spectrum blocks usable by a transmitter or receiver, (iii) spectrum codes, and (iv) spectrum time slots;
the one or more resource parameters include at least one of: (i) thermal noise corresponding to a spectrum block and (ii) external interference corresponding to a spectrum block; and
the policy includes at least one of: (i) one or more spectrum blocks for the particular user to use, (ii) a transmission power for the particular user to use, (iii) a transmission rate for the particular user to use, (iv) a network access point for the particular user to use, (v) a spectrum code for the particular user to use, and (vi) a spectrum time slot for the particular user to use.

10. The invention of claim 8, wherein the processor is adapted to generate the policy by solving a linear-programming problem having primal and dual sets of constraints based on the one or more user parameters and the one or more resource parameters.

11. The invention of claim 8, wherein at least one of a transmitter and a receiver associated with the particular user automatically adopts the transmitted policy.

12. The invention of claim 8, wherein at least one of a transmitter and a receiver associated with the particular user is adapted to be manually configured by a human actor to adopt the policy.

13. The invention of claim 8, wherein at least one of the one or more receivers and the one or more transmitters comprises at least one of: (i) a software-defined radio and (ii) an antenna or antenna array adapted to be tuned dynamically to different spectrum bands or blocks.

14. The invention of claim 8, wherein the wireless-resource broker has no enforcement capability to ensure that the particular user adopts the transmitted policy.

15. A communications device for use with a wireless-resource broker for allocating wireless resources among a plurality of users, the communications device comprising:
a receiver adapted to receive, from the wireless-resource broker, a policy for using one or more of the wireless resources; and
a processor adapted to selectively adopt or ignore the policy.

16. The invention of claim 15, wherein the policy is such that an expected utility that the communications device obtains by adopting the policy is not less than the expected utility that the communications device obtains by adopting an alternative strategy.

17. The invention of claim 15, wherein the policy is based on (i) one or more user parameters characterizing at least one of one or more receivers and one or more transmitters associated with one or more of the users and (ii) one or more resource parameters characterizing one or more wireless resources; and
further comprising a transmitter adapted to provide to the wireless broker at least one of the one or more user parameters.

18. The invention of claim 15, wherein the processor is adapted to automatically selectively adopt the policy.

19. The invention of claim 15, wherein the processor is adapted to be manually configured by a human actor to selectively adopt the policy.

20. The invention of claim 15, wherein the communications device comprises at least one of: (i) a software-defined radio and (ii) an antenna or antenna array adapted to be tuned dynamically to different spectrum bands or blocks.
